(19) United States
(12) Patent Application Publication
(10) Pub. No.: US 2021/0097023 A1
(43) Pub. Date: Apr. 1, 2021

(54) Decentralized Data System

(71) Applicant: Solutech, Inc., New Haven, CT (US)

(72) Inventors: Christopher T. Hayes, Westbrook, CT (US); Nathan Pitruzzello, New Haven, CT (US); Joseph W. Nicklas, Hamden, CT (US); Samuel L. Opper, Stamford, CT (US)

(21) Appl. No.: 16/585,188

(22) Filed: Sep. 27, 2019

(51) Int. Cl. G06F 16/13; G06F 16/638; G06F 16/738; G06F 16/14; H04L 29/08

(52) U.S. Cl. CPC G06F 16/134; G06F 16/638; H04L 67/06; G06F 16/156; G06F 16/738

(57) ABSTRACT

A managed file transfer system having a computer, a database in data communication with said computer, software executing on said computer for receiving a user authorization and a connection request from a user device, software executing on said computer for sending the request to at least one authorized device and receiving an approval from the at least one authorized device, software executing on said computer for providing connection details to the user device and the at least one authorized device, and software executing on said computer for recording at least one of the connection request and the approval on the database.

### TECHNICAL FIELD

The present invention generally relates to a decentralized data system, and specifically to a managed file transfer system facilitating peer-to-peer file transfers.

### BACKGROUND

Conventional file sharing systems require that users transmit documents and data for storage on their platforms. This leads to a number of problems.

First, users are required to trust that their data will be safe and secure. However, data breaches are common and placing any data online means that it can be compromised. As a result, it is desirable to provide a system that maintains the privacy and ownership of data.

Second, it is inconvenient to require users to upload files to a central system for them to be accessible. Users are forced to wait until documents are uploaded before they can be downloaded. As a result, a system that does not require documents to be uploaded to a server is necessary.

Finally, conventional systems may include data restrictions, either by file size or upload and download speeds. These restrictions may be arbitrary and set by the system. Therefore, it is necessary to provide a system that contains no system-imposed limitations on its use.

### SUMMARY

An object of the invention is to grant accessibility to files without any dependence on could storage or the need to pre-emptively store files in multiple locations.

It is a further object of the invention to provide a system that takes no rights or claims to any data transferred by users beyond what is necessary for the system to function (e.g., authentication, device information, etc.).

It is a further object of the invention to provide a system that does not restrict user upload and download speeds.

It is a further object of the invention to provide a system that has no file size limits.

It is another object of the invention to encrypt all data in transit.

In addition, it is an object of the invention to provide a system that allows access of files from remote devices.

In one aspect of the invention, a managed file transfer system is provided having a computer, a database in data communication with said computer, software executing on said computer for receiving a user authorization and a connection request from a user device, software executing on said computer for sending the request to at least one authorized device and receiving an approval from the at least one authorized device, software executing on said computer for providing connection details to the user device and the at least one authorized device, and software executing on said computer for recording at least one of the connection request and the approval on the database.

In another aspect of the invention, a managed file transfer system is provided having an authorization server in communication with a user database receiving a user authorization from a first device, a network server transmitting connection information to at least one of the first device and a second device, a signal server receiving at least one of a connection request and transmitting the connection request to the second device, wherein the first device and the second device establish a direct connection based on the connection information.

Other embodiments of the system are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of the presently disclosed system.

FIG. 2 is a schematic diagram of the presently disclosed system.

### DETAILED DESCRIPTION

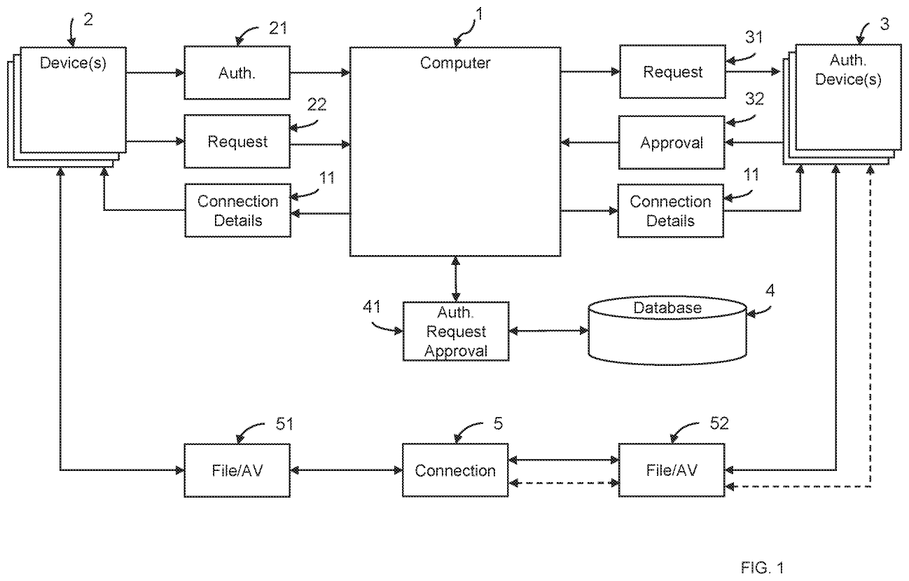

Referring to FIG. 1, the present disclosure describes a system 10 for facilitating file transfers.

The system 10 includes a computer 1. The computer 1 may be a processor, remote computer, computer server, network, or any other computing resource. The computer 1 may be in data communication with device(s) 2. The devices 2 may include any device capable of storing electronic files, including a computer, laptop, smartphone, tablet, television, speaker, etc.

The computer 1 may also be in data communication with authorized devices 3. The authorized devices 3 may include any device capable of storing electronic files, including a computer, laptop, smartphone, tablet, television, speaker, etc. that has previously authenticated with the computer 1. The authorized devices 3 may also include any cloud storage system, including those provided by Dropbox, Microsoft (OneDrive), Apple (iCloud), etc.

The computer 1 may also be in communication with a database 4. The database 4 may store information regarding the system 10, including information as discussed below.

The computer 1 receives an authorization 21 from the device 2. The authorization 21 may include information that verifies that the device 2 may use an account. For example, the authorization 21 may be a username and password, a cryptographic key, system identification, database of verification or other manner of identification. Two-factor authorization, or any other manner of establishing a level of trust in the identity of the user of the device may be employed.

The computer 1 receives a request 22 from the device 2. The request 22 may indicate that the device 2 requests to send and/or receive a file to an authorized device 3. For example, a user on their tablet may request to transfer a file to their smartphone. In addition, the request 22 may indicate that files should be transferred between two or more authorized devices 3. For example, a user on their smart phone may request to transfer a file from their home computer to their work computer. The request 22 may or may not indicate the file sought to be transferred.

In response to receiving the request 22, the computer 1 may transmit the request 31 to the authorized device 3. The computer may modify the request 22 to generate the request 31, such as to identify the requesting device 3, include a timestamp, or provide any other information.

The computer 1 may receive an approval 32 from the authorized device 3 in response to receiving the request 31. The approval 32 may indicate that the requested file transfer may occur. If the approval indicates that the request 31 is approved, a notification may be sent to the device 2. If no approval 32 is received by the computer 1, or of the request 31 is declined, the computer may send a notification to the device 2.

In addition, the computer 1 may determine if the authorized device 3 previously provided an approval 32 to perform the requested file transfer by querying the database 4. For example, a user may have previously authorized all transfers between their smartphone and their laptop. As another example, an employee may previously authorize their manager to send files to the employee's work computer. The previously provided approval 32 may be at the account level or at the device level. Particular users and devices may be approved for transferring files by identifying a username, cryptographic key, or other method.

If the approval 32 indicates that the file transfer is authorized, the computer 1 may send connection details 11 to the device 2 and/or authorized device(s) 3. The connection details 11 may indicate that the request 22 is approved. The connection details 11 may specify how the appropriate device 2 and/or authorized device(s) 3 may connect to one another. The connection details 11 may include IP addresses and ports. The connection details 11 may also include cryptographic keys for securing the connection.

Using the connection details 11, the device 2 and/or authorized device(s) 3 establish a connection 5. Files, audio, and video 51 and 52 may be sent over the connection 5 between the device 2 and/or authorized device(s) 3. For example, device 2 and/or authorized device(s) 3 can now share directory file information (to view file system contents), upload and download files, stream voice and video from an existing file, stream voice and video captured from users multimedia device (such as a camera and a microphone).

The system 10 allows for features such as automatic backup when pre-authorization is utilized. For example, a device 2 (e.g., a laptop) can be set to automatically back up files to another authorized device 3 (e.g., network attached storage or cloud storage). The request 22 to backup a device 2 can be generated by the device 2, the computer 1, or the target authorized device 3. A connection 5 will then be established between the device 2 and target authorized device 3, and the files will be backed up. A date and time may be specified to perform the backup on a recurring or one-time basis. Specific file(s) or folder(s) may be specified to be backed up. These settings may be saved in the database 4, or on a device 2 or 3. Local transfer of files between folders on a single device can also be set up, rather than to a different device.

In addition, mobile devices may also back up photographs automatically. Upon taking a photograph, a request 22 can be generated by the mobile device 2 and sent to the computer 1 to automatically save the photograph to the user's laptop 3, which has previously been authenticated. A connection 5 between the mobile device 2 and the laptop 3 can be established, and the photograph will be backed up. Optionally, the mobile device 2 may be set to delete the photograph from the mobile device 2 once after it is backed up.

In another aspect of the present invention, file transfers may be queued before being executed. For example, a file to be copied can be identified on a device 2. Identifying a file may also include identifying where they are to be transferred to, either on the device 2 or another authorized device 3. When all files are identified, a request 22 can be sent to the computer, and the files will be transferred. In some instances, icons representing the files can be dragged or copied to a portion of the screen (hereinafter called the “clipboard”) and subsequently displayed in the clipboard. A user may determine when to transfer all files in the clipboard. Alternatively, the user may drag an icon representing a file from the clipboard to a file location, at which point the file will be copied from the original file system location to the new desired location, whether on the same device 2 or a different device 3.

In another aspect of the present invention, the authorized device 3 may prompt its user to accept or deny a request 31. The prompt may indicate the file sought to be transferred, the device 2 requesting the transfer, and/or user information (which may be taken from the authorization 21). In some embodiments, the user may slide a graphical element displayed on the device 3 to accept or deny the file transfer. Once accepted or denied, the graphical elements will be removed from the screen.

Information regarding the connection 5 may be stored in the database 4. For example, any of the authorization 21, the request 22 and 31, the approval 32, and the connection details 11 may be stored in the database 4. In addition, information such as timestamps may also be stored.

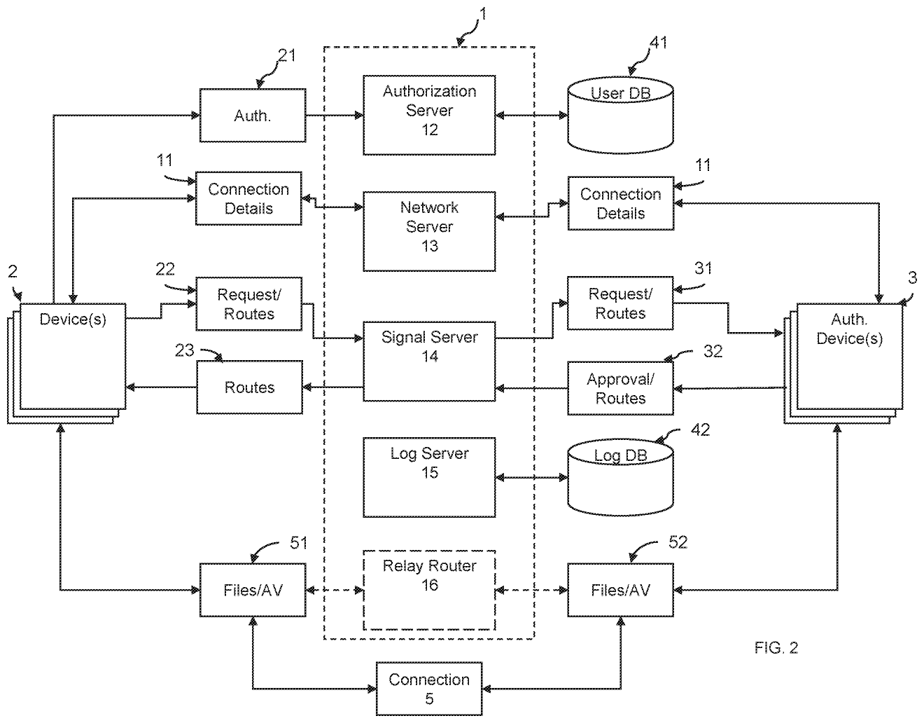

In another aspect of the present invention shown in FIG. 2, computer 1 may include an authorization server 12, a network server 13, a signal server 14, a log server 15, and a relay router 16. Each of the authorization server 12, network server 13, signal server 14, log server 15, and relay router 16 may be in data communication with one another, and with devices 2 and authorized devices 3.

The authorization server 21 is in data communication with user database 41, which stores the data required to validate authentications 21. The authorization server 21 receives an authorization 21 from the device 2. The authorization server 12 checks the authorization 21 against the user database 41 to validate authorization 21.

Network server 13 may provide connection details 11 to device 2. Connection details 11 may include a list of available routes which may be used to establish a connection with the device 2. The routes may include a list of IP addresses and ports, or other appropriate network information. In some embodiments, network server 13 may be a STUN server, and the routes may be provided in session description protocol (SDP).

Signal server 14 is in data communication with device 2 and authorized device(s) 3. Signal server 14 allows device 2 and authorized device(s) 3 to all be visible to one another. In some cases, signal server 14 may be configured to allow only a subset of devices to be visible to one another, or require authorization before allowing a device to be visible.

Signal server 14 may receive a request 22 from the device 2. The request 22 may indicate that the device 2 wants to send and/or receive a file to an authorized device 3. Request 22 may also include one or more routes 22. Signal server transmits request 31 to the authorized device 3.

Signal server 14 may receive an approval 32 from the authorized device 3 in response to receiving the request 31. Approval 32 may include one or more routes 32. Signal server 14 may provide these routes 23 to device 2. In some embodiments, the routes 23 may be provided as an updated SDP. In some embodiments, signal server 14 may track and broadcast the identity of devices 2 connected to the system 10.

The device 2 and authorized device 3 will attempt to establish a connection 5 to connect directly with one another using the routes they exchanged. If a direct connection cannot be established, the device 2 and authorized device 3 can use relay router 16 to establish a connection. In some embodiments, the relay router 16 is a Traversal Using Relays around NAT (TURN) server. Either way, files, audio, and video 51 and 52 may be sent over the connection between the device 2 and authorized device(s) 3.

Log server 15 may receive information from other parts of the computer 1 for storing on the log database 42. For example, any of the authorization 21, the requests and routes 22 and 31, the approval and routes 32 and 23, and the connection details 11 may be stored in the database 4. In addition, information such as timestamps may also be stored.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A managed file transfer system, comprising:
a computer;
a database in data communication with said computer;
software executing on said computer for receiving a user authorization and a connection request from a user device;
software executing on said computer for sending the request to at least one authorized device and receiving an approval from the at least one authorized device;
software executing on said computer for providing connection details to the user device and the at least one authorized device;
software executing on said computer for recording at least one of the connection request and the approval on the database.

2. The system of claim 1, wherein the user device and the at least one authorized device establish a connection based on the connection details.

3. The system of claim 2, wherein at least one file is transferred over the connection.

4. The system of claim 3, wherein the file is transferred from the at least one authorized device to the user device.

5. The system of claim 4, wherein the file is transferred from at least two authorized devices to the user device.

6. The system of claim 3, wherein the file is transferred from the user device to the at least one authorized device.

7. The system of claim 1, at least one authorized device and another at least one authorized device establishes a connection based on the connection details, and at least one file is transferred at least one authorized device the another at least one authorized device.

8. The system of claim 2, wherein audio is transferred over the connection.

9. The system of claim 2, wherein video is transferred over the connection.

10. The system of claim 1, further comprising software executing on said computer for recording the connection details on the database.

11. A managed file transfer system, comprising:
an authorization server in communication with a user database receiving a user authorization from a first device;
a network server transmitting connection information to at least one of the first device and a second device;
a signal server receiving at least one of a connection request and transmitting the connection request to the second device;
wherein the first device and the second device establish a direct connection based on the connection information.

12. The system of claim 11, wherein a relay router establishes the direct connection.

13. The system of claim 11, the signal server receives routes from at least one of the first device and the second device and provides them to the other of the first device and second device.

14. The system of claim 11, wherein at least one of a file, audio, or video, is transferred over the direct connection.

15. The system of claim 13, wherein at least one of the connection request, routes, connection information, and file information is provided to a log server for recording on a log database.
